(19) United States
(12) Patent Application Publication
(10) Pub. No.: US 2026/0192857 A1
(43) Pub. Date: Jul. 9, 2026

(54) SUSPENSION MEMBER

(71) Applicant: TOYOTA JIDOSHA KABUSHIKI KAISHA, Toyota-shi (JP)

(72) Inventor: Takahiro ITO, Toyota-shi (JP)

(73) Assignee: TOYOTA JIDOSHA KABUSHIKI KAISHA, Toyota-shi (JP)

(21) Appl. No.: 19/393,228

(22) Filed: Nov. 18, 2025

(30) Foreign Application Priority Data
Dec. 10, 2024 (JP) 2024-215279

(51) Int. Cl. B62D 21/02

(52) U.S. Cl. CPC B62D 21/02

(57) ABSTRACT

A suspension member includes: a tubular mount attachment portion that is fixed to a vehicle body; a rib provided along a circumferential direction on an outer peripheral surface of the mount attachment portion; and a recess provided along the circumferential direction on an inner peripheral surface of the mount attachment portion and located within the range of the width of the rib in an axial direction.

### CROSS-REFERENCE TO RELATED APPLICATION

This application claims priority to Japanese Patent Application No. 2024-215279 filed on Dec. 10, 2024. The disclosure of the above-identified application, including the specification, drawings, and claims, is incorporated by reference herein in its entirety.

### BACKGROUND

### 1. Technical Field

The present disclosure relates to suspension members.

### 2. Description of Related Art

Japanese Unexamined Patent Application Publication No. 2012-041009 (JP 2012-041009 A) discloses a configuration of a suspension member on which a motor is mounted. Conventionally, a body mount has been used to support a suspension member on a vehicle body. The body mount, also referred to as a rubber bushing, includes an inner cylinder, an outer cylinder, and an elastic body interposed between the inner and outer cylinders. This elastic body absorbs vibrations associated with vertical movement of the suspension member relative to the vehicle body.

### SUMMARY

In order to reduce the number of components of a body mount, a resin outer cylindrical member may be employed. However, the resin outer cylindrical member is subject to significant dimensional changes due to temperature variations. Therefore, it is desired to set a large interference to ensure sufficient retention force. However, when the interference is set too large, the resin outer cylindrical member may crack when press-fitted into a mount attachment portion.

The present disclosure has been made in view of the above circumstances, and an object thereof is to provide a suspension member capable of reducing the possibility of cracking of a resin outer cylindrical member during press-fitting.

A suspension member of claim 1 of the present disclosure includes: a tubular mount attachment portion that is fixed to a vehicle body; a rib provided along a circumferential direction on an outer peripheral surface of the mount attachment portion; and a recess provided along the circumferential direction on an inner peripheral surface of the mount attachment portion and located within the range of the width of the rib in an axial direction.

In the suspension member of claim 1 of the present disclosure, the rib is provided along the circumferential direction on the outer peripheral surface of the mount attachment portion, and the recess is located within the range of the width of the rib in the axial direction. This configuration can reduce a decrease in radial wall thickness of the mount attachment portion, thereby ensuring sufficient rigidity of the mount attachment portion. In addition, the recess helps increase retention force of a resin outer cylindrical member that has a protrusion on its outer periphery. This makes it possible to reduce an increase in interference, thereby reducing the possibility of cracking of the resin outer cylindrical member during press-fitting.

According to a suspension member of claim 2 of the present disclosure, in the configuration of claim 1, a corner portion of an inner surface of the mount attachment portion is provided as a convex curved surface, and the corner portion is located at one end into which the resin outer cylindrical member is press-fitted.

In the suspension member of claim 2 of the present disclosure, the corner portion of the inner surface that is located at the one end into which the resin outer cylindrical member is press-fitted is provided as a convex curved surface. This configuration reduces the possibility that the protrusion provided on the outer periphery of the resin outer cylindrical member may crack at the corner portion during press-fitting of the resin outer cylindrical member.

According to a suspension member of claim 3 of the present disclosure, in the configuration of claim 1 or 2, an angle provided inside the recess between a first surface located on a side opposite to one end into which the resin outer cylindrical member is press-fitted and an inner surface of the mount attachment portion is greater than or equal to 15 degrees and less than or equal to 30 degrees.

In the suspension member of claim 3 of the present disclosure, the angle provided inside the recess between the first surface located on the side opposite to the one end into which the resin outer cylindrical member is press-fitted and the inner surface of the mount attachment portion is greater than or equal to 15 degrees and less than or equal to 30 degrees. This configuration reduces the possibility that the protrusion provided on the outer periphery of the resin outer cylindrical portion may crack when the protrusion engages with the recess.

According to a suspension member of claim 4 of the present disclosure, in the configuration of any one of claims 1 to 3, an angle provided outside the recess between a second surface located on a side closer to one end into which the resin outer cylindrical member is press-fitted and an inner surface of the mount attachment portion is greater than or equal to 80 degrees and less than or equal to 100 degrees.

In the suspension member of claim 4 of the present disclosure, the angle provided outside the recess between the second surface located on the side closer to the one end into which the resin outer cylindrical member is press-fitted and the inner surface of the mount attachment portion is greater than or equal to 80 degrees and less than or equal to 100 degrees. This configuration reduces the possibility that the protrusion provided on the outer periphery of the resin outer cylindrical member may come off from the recess.

According to a suspension member of claim 5 of the present disclosure, in the configuration of any one of claims 1 to 4, the recess is provided such that the radial wall thickness of the mount attachment portion at the recess is substantially the same as the radial wall thickness of the mount attachment portion in a region other than the recess.

In the suspension member of claim 5 of the present disclosure, the radial wall thickness of the mount attachment portion can be made uniform. Therefore, the rigidity of the mount attachment portion can be maintained.

As described above, the suspension member according to the present disclosure can reduce the possibility of cracking of a resin outer cylindrical member during press-fitting.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view of a suspension member etc. according to an embodiment of the present disclosure;

FIG. 2 is a schematic side view of the suspension member etc. according to the embodiment of the present disclosure;

FIG. 3 is a schematic perspective view illustrating an example of a structure including a main portion of the suspension member according to the embodiment of the present disclosure;

FIG. 4 is a longitudinal sectional view taken along line IV-IV in FIG. 3; and

FIG. 5 is a longitudinal sectional view showing part of a mount attachment portion of the suspension member.

### DETAILED DESCRIPTION OF EMBODIMENTS

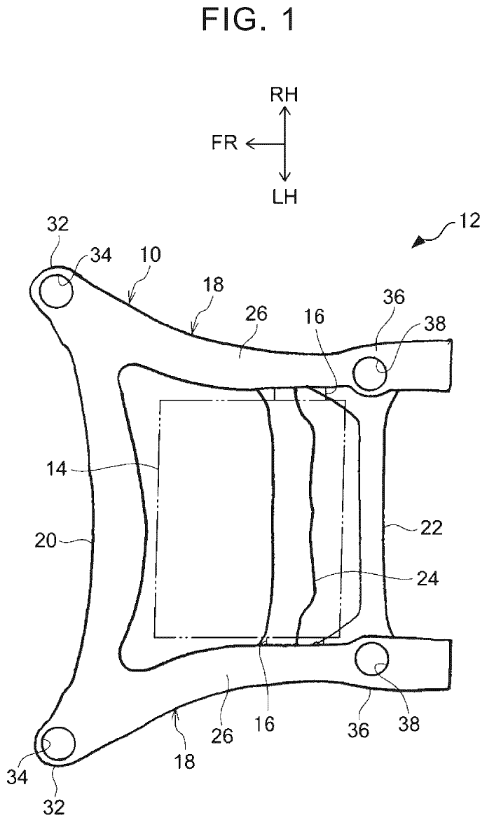

A suspension member 10 according to an embodiment of the present disclosure will be described below with reference to FIGS. 1 to 5. In the present specification and drawings, components having substantially the same functional configurations are denoted by the same signs, and redundant descriptions thereof will be omitted. In the drawings, arrow FR indicates the front side in the vehicle front-rear direction, and arrow UP indicates the upper side in the vehicle up-down direction. Arrow LH indicates the left side in the vehicle width direction (left-right direction), and arrow RH indicates the right side in the vehicle width direction (left-right direction). Hereinafter, the terms “front,” “rear,” “upper,” “lower,” “left,” and “right” refer to front and rear in the vehicle front-rear direction, upper and lower in the vehicle up-down direction, and left and right in the vehicle left-right direction (vehicle width direction), respectively, unless otherwise specified.

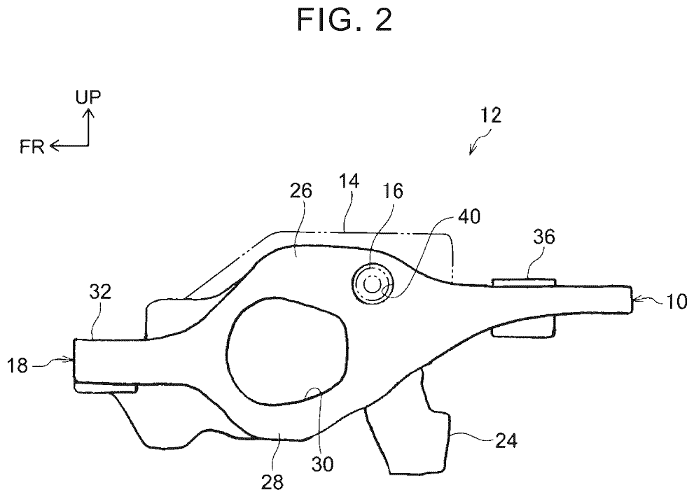

As shown in FIGS. 1 and 2, the suspension member 10 of the present embodiment is provided, as an example, at the rear of a vehicle 12. Various arms etc. (not shown) for supporting the right and left rear wheels are attached to the suspension member 10. The portions of the suspension member 10 to which these arms are attached are not shown in FIGS. 1 and 2. A motor 14 for driving the right and left rear wheels is supported on the suspension member 10 via a motor mount 16. The motor mount 16 is attached to motor mount attachment holes 40 (see FIG. 2) each formed in a corresponding one of upper intermediate member portions 26 and extending therethrough in the vehicle width direction.

The suspension member 10 is formed by, for example, aluminum die casting, and has a configuration in which the portions described below are integrally formed. For example, the suspension member 10 include: a pair of right and left side member portions 18 that extends in the front-rear direction at both sides in the vehicle width direction; a front cross member portion 20 that connects the front ends of the right and left side member portions 18 in the left-right direction; a rear cross member portion 22 that connects the rear ends of the right and left side member portions 18 in the left-right direction; and an intermediate cross member portion 24 that connects, in the left-right direction, intermediate portions of the right and left side member portions 18 in the front-rear direction.

As shown in FIG. 1, a region from a central portion in the front-rear direction to a front end of each side member portion 18 has a gently curved shape that curves outward in the vehicle width direction as it extends toward the front, as viewed from above. As shown in FIG. 2, the intermediate portion of each side member portion 18 in the front-rear direction includes an upper intermediate member portion 26 that extends in the front-rear direction, and a lower intermediate member portion 28 that extends in the front-rear direction below the upper intermediate member portion 26. An opening 30 is formed between the upper intermediate member portion 26 and the lower intermediate member portion 28. A drive shaft that transmits rotation of the motor 14 to the rear wheels is inserted through the opening 30 in the left-right direction.

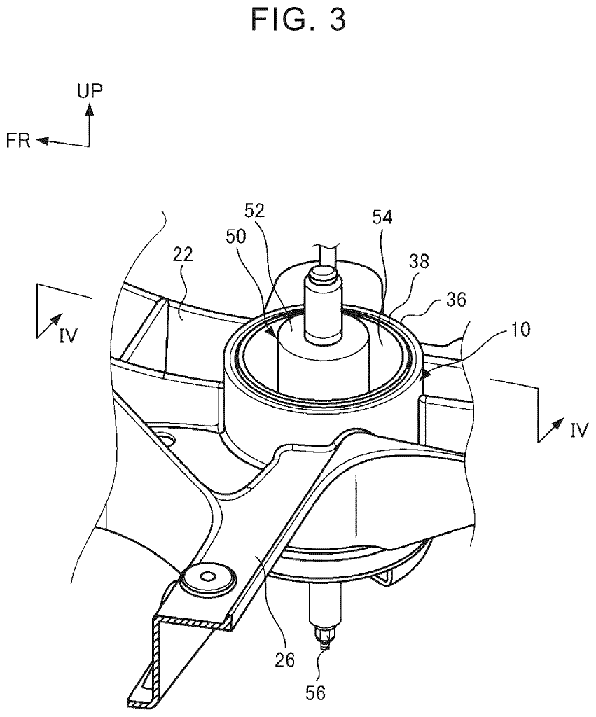

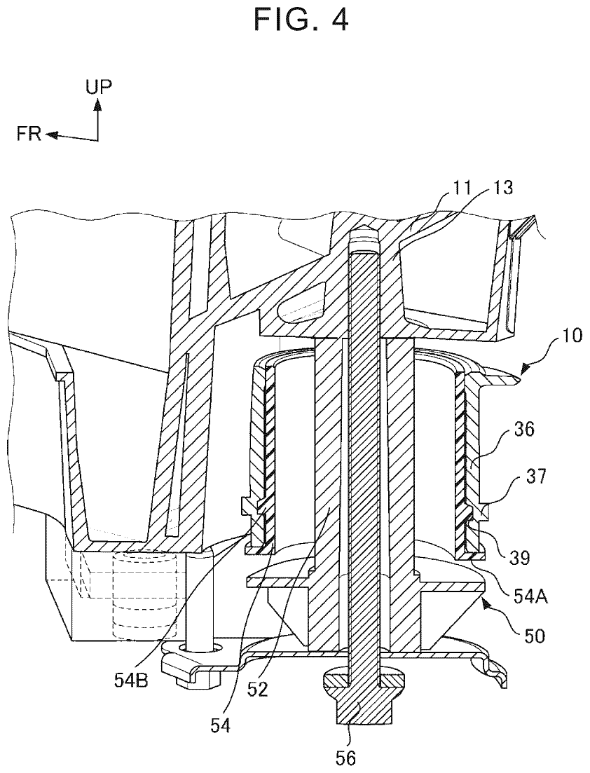

As shown in FIGS. 1 and 2, a front mount attachment portion 32 is provided at the front end of each side member portion 18. The front mount attachment portion 32 is a tubular mount attachment portion that is fixed to a vehicle body 11 (see FIG. 4). A front mount attachment hole 34 is formed in the front mount attachment portion 32. A body mount 50 (see FIGS. 3 and 4), which will be described later, is press-fitted in the front mount attachment hole 34. The body mount 50 press-fitted in the front mount attachment hole 34 is fixed to the vehicle body 11 (see FIG. 4), whereby the front mount attachment portion 32 is fixed to the vehicle body 11.

A rear mount attachment portion 36 is provided at the rear end of each side member portion 18. The rear mount attachment portion 36 is a tubular mount attachment portion that is fixed to the vehicle body 11 (see FIG. 4). A rear mount attachment hole 38 is formed in the rear mount attachment portion 36. A body mount 50 (see FIGS. 3 and 4), which will be described later, is press-fitted in the rear mount attachment hole 38. The body mount 50 press-fitted in the rear mount attachment hole 38 is fixed to the vehicle body 11 (see FIG. 4), whereby the rear mount attachment portion 36 is fixed to the vehicle body 11.

As shown in FIG. 1, the front cross member portion 20 has, for example, a gently curved shape that curves rearward toward the center in the vehicle width direction, as viewed from above, and is spanned between the front mount attachment portions 32 of the right and left side member portions 18. For example, the rear cross member portion 22 is spanned between the rear mount attachment portions 36 of the right and left side member portions 18. As shown in FIGS. 1 and 2, the intermediate cross member portion 24 is spanned between the rear ends of the lower intermediate member portions 28 of the right and left side member portions 18.

The front mount attachment portion 32 and the rear mount attachment portion 36 that serve as the mount attachment portions will now be described in detail. Although the rear mount attachment portion 36 will be described in the present embodiment, the configuration of the rear mount attachment portion 36 is also applicable to the front mount attachment portion 32.

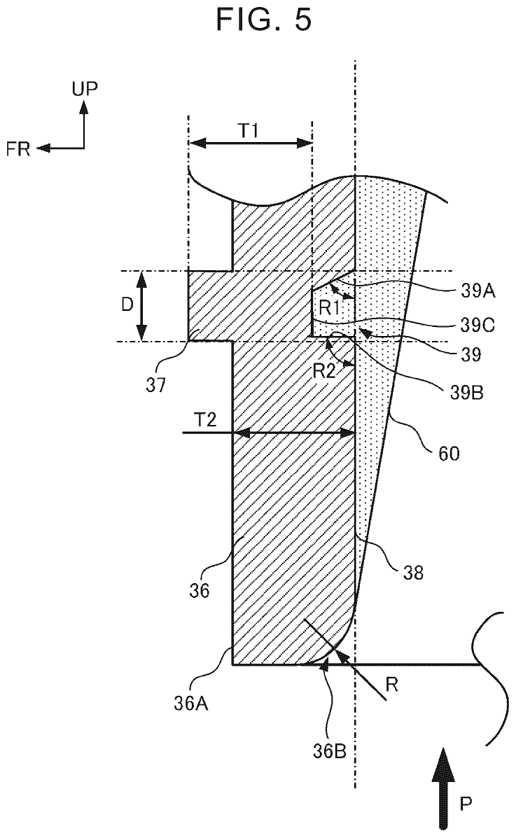

As shown in FIGS. 3 and 4, the rear mount attachment portion 36 of the present embodiment is connected to the rear cross member portion 22 and the side member portion 18, and is formed in a tubular shape having the rear mount attachment hole 38 therein. As shown by arrow P in FIG. 5, the body mount 50 (see FIGS. 3 and 4) is press-fitted into and supported in the rear mount attachment hole 38 from below in the up-down direction.

As shown in FIGS. 4 and 5, the rear mount attachment portion 36 includes a rib 37 provided along the circumferential direction on its outer peripheral surface 36A. The rib 37 protrudes outward and has a substantially rectangular cross-section. The rib 37 has a width D in the up-down direction, that is, the axial direction.

The rear mount attachment portion 36 also has a recess 39 formed along the circumferential direction on its inner peripheral surface, that is, in the rear mount attachment hole 38. As shown in FIG. 5, the recess 39 is formed within the range of the width D of the rib 37 in the up-down direction, that is, the axial direction. The recess 39 includes an upper surface 39A, a lower surface 39B that faces the upper surface 39A, and a bottom surface 39C that connects the upper surface 39A and the lower surface 39B and extends in the up-down direction.

In the present embodiment, for example, the recess 39 is formed such that the radial wall thickness T1 of the rear mount attachment portion 36 at the recess 39 is substantially the same as the radial wall thickness T2 of the rear mount attachment portion 36 in the regions other than the recess 39. As used herein, “approximately the same wall thickness” includes both cases where the numerical values exactly match and cases where the numerical values are slightly different within the range of manufacturing tolerances etc.

As shown in FIG. 5, the recess 39 is formed such that an angle R1 is, for example, greater than or equal to 15 degrees and less than or equal to 30 degrees. The angle R1 is an angle formed inside the recess 39 between the upper surface (first surface) 39A located on the side opposite to one end into which the body mount 50 (see FIGS. 3 and 4) is press-fitted (i.e., on the side opposite to the lower side) and the inner surface of the rear mount attachment portion 36 (i.e., the inner peripheral surface of the rear mount attachment hole 38). The recess 39 is also formed such that an angle R2 is, for example, greater than or equal to 80 degrees and less than or equal to 100 degrees. The angle R2 is an angle formed outside the recess 39 between the lower surface (second surface) 39B located on the side closer to the one end into which the body mount 50 (see FIGS. 3 and 4) is press-fitted and the inner surface of the rear mount attachment portion 36 (i.e., the inner peripheral surface of the rear mount attachment hole 38).

A corner portion 36B of the inner surface of the rear mount attachment portion 36 located on the lower side (i.e., located at the one end into which the body mount 50 (see FIGS. 3 and 4) is press-fitted) is formed as a convex curved surface. That is, the corner portion 36B has, for example, a rounded shape.

In the present embodiment, for example, the front mount attachment portions 32 and the rear mount attachment portions 36 are included in the suspension member 10, and are integrally formed with the right and left side member portions 18, the front cross member portion 20, the rear cross member portion 22, and the intermediate cross member portion 24 by, for example, aluminum die casting. Therefore, in the present embodiment, the press-fit inner diameter and a cast surface 60 are provided such that the corner portion 36B has a rounded shape. In the present embodiment, for example, the front mount attachment hole 34, the rear mount attachment hole 38, and the recess 39 are formed by machining the cast surface 60, as indicated by the shaded area in FIG. 5.

Next, the body mount 50 will be described. The body mount 50 is a support component that supports the suspension member 10 on the vehicle body 11. For example, four body mounts 50 are provided on the vehicle. The body mount 50 also serves as a vibration-damping component that reduces transmission of vibration from the suspension member 10 to the vehicle body 11. As shown in FIGS. 3 and 4, the body mount 50 includes an inner cylinder 52 and a resin outer cylindrical member 54 made of resin. The inner cylinder 52 extends in the up-down direction, that is, the axial direction. For example, the inner cylinder 52 is fastened and fixed to the vehicle body 11 via a bolt 56 and a stud nut 13.

The resin outer cylindrical member 54 is made of, for example, heat-resistant resin, and is coaxial with the inner cylinder 52. A predetermined radial clearance is provided between the outer peripheral surface of the inner cylinder 52 and the inner peripheral surface of the resin outer cylindrical member 54. The resin outer cylindrical member 54 includes, at its lower end, a flange 54A that extends radially outward. The upper surface of the flange 54A comes into contact with the lower end face of the front mount attachment portion 32 when the body mount 50 is press-fitted into the front mount attachment hole 34. The upper surface of the flange 54A comes into contact with the lower end face of the rear mount attachment portion 36 when the body mount 50 is press-fitted into the rear mount attachment hole 38.

The resin outer cylindrical member 54 also includes, on its outer peripheral surface, a protrusion 54B provided along the circumferential direction. The protrusion 54B is provided at a position corresponding to the recess 39 formed in each of the front and rear mount attachment portions 32, 36, and is fitted in the recess 39. In the present embodiment, for example, the protrusion 54B has a substantially rectangular cross-section.

As described above, the body mounts 50 are press-fitted into the front mount attachment hole 34 and the rear mount attachment hole 38, respectively. The resin outer cylindrical members 54 are thus joined (fixed) to the front mount attachment portion 32 and the rear mount attachment portion 36, respectively.

### Functions and Effects

Next, the functions and effects of the present embodiment will be described.

In order to reduce the number of components of a body mount, a resin outer cylindrical member may be employed. However, the resin outer cylindrical member is subject to significant dimensional changes due to temperature variations. Therefore, it is desired to set a large interference to ensure sufficient retention force. However, when the interference is set too large, the resin outer cylindrical member may crack when press-fitted into a mount attachment portion.

Accordingly, in the suspension member 10 of the present embodiment, the rib 37 is provided along the circumferential direction on the outer peripheral surface of the mount attachment portion (i.e., on the outer peripheral surface of the front mount attachment portion 32 and the outer peripheral surface of the rear mount attachment portion 36), and the recess 39 is formed within the range of the width D of the rib 37 in the up-down direction, that is, the axial direction. This configuration can reduce a decrease in radial wall thickness of the mount attachment portion (i.e., the front mount attachment portion 32 and the rear mount attachment portion 36), thereby ensuring sufficient rigidity of the front mount attachment portion 32 and the rear mount attachment portion 36. In addition, the recess 39 helps increase the retention force of the resin outer cylindrical member 54 that has the protrusion 54B on its outer periphery. This makes it possible to reduce an increase in interference, thereby reducing the possibility of cracking of the resin outer cylindrical member during press-fitting.

In the suspension member 10 of the present embodiment, the corner portion 36B of the inner surface located at the one end into which the resin outer cylindrical member 54 is press-fitted (i.e., located on the lower side) is formed as a convex curved surface. This configuration reduces the possibility that the protrusion 54B formed on the outer periphery of the resin outer cylindrical member 54 may crack at the corner portion 36B during press-fitting of the resin outer cylindrical member 54.

In the suspension member 10 of the present embodiment, the angle R1 formed inside the recess 39 between the upper surface (first surface) 39A located on the side opposite to the one end into which the resin outer cylindrical member 54 is press-fitted (i.e., on the side opposite to the lower side) and the inner surface of the rear mount attachment portion 36 (i.e., the inner peripheral surface of the rear mount attachment hole 38) is, for example, greater than or equal to 15 degrees and less than or equal to 30 degrees. This configuration reduces the possibility that the protrusion 54B formed on the outer periphery of the resin outer cylindrical member 54 may crack when the protrusion 54B engages with the recess 39.

In the suspension member 10 of the present embodiment, the angle R2 formed outside the recess 39 between the lower surface (second surface) 39B located on the side closer to the one end into which the resin outer cylindrical member 54 is press-fitted (i.e., on the lower side) and the inner surface of the rear mount attachment portion 36 (i.e., the inner peripheral surface of the rear mount attachment hole 38) is, for example, greater than or equal to 80 degrees and less than or equal to 100 degrees. This configuration reduces the possibility that the protrusion 54B formed on the outer periphery of the resin outer cylindrical member 54 may come off downward from the recess 39.

In the suspension member 10 of the present embodiment, the radial wall thickness of the mount attachment portion (i.e., the front mount attachment portion 32 and the rear mount attachment portion 36) can be made uniform. Therefore, the rigidity of the mount attachment portion (i.e., the front mount attachment portion 32 and the rear mount attachment portion 36) can be maintained.

### Supplementary Description

In the above embodiment, the rib 37 has a substantially rectangular cross-section. However, the shape of the rib 37 is not limited to the substantially rectangular shape, and the rib 37 may have any shape. In the above embodiment, the rib 37 is provided along the circumferential direction. That is, the rib 37 is provided continuously. However, the present disclosure is not limited to this. For example, the rib 37 may be provided intermittently. Even when the rib 37 is provided intermittently, the rigidity can be increased compared to a configuration in which the rib is not provided.

In the above embodiment, the recess 39 is formed such that the radial wall thickness T1 of the rear mount attachment portion 36 at the recess 39 is substantially the same as the radial wall thickness T2 of the rear mount attachment portion 36 in the regions other than the recess 39. However, the present disclosure is not limited to this. For example, the radial wall thickness T1 of the rear mount attachment portion 36 at the recess 39 may be larger than or smaller than the radial wall thickness T2 of the rear mount attachment portion 36 in the regions other than the recess 39. From the standpoint of rigidity, however, it is preferable that the wall thickness T1 be larger rather than smaller.

The configuration of the present disclosure is not limited to the above embodiment, and modifications may be made as appropriate as long as the issue can be resolved.

What is claimed is:

1. A suspension member comprising:
a mount attachment portion that is fixed to a vehicle body, the mount attachment portion having a tubular shape;
a rib provided along a circumferential direction on an outer peripheral surface of the mount attachment portion; and
a recess provided along the circumferential direction on an inner peripheral surface of the mount attachment portion, the recess being located within a range of a width of the rib in an axial direction.

2. The suspension member according to claim 1, wherein a corner portion of an inner surface of the mount attachment portion is provided as a convex curved surface, the corner portion being located at one end into which a resin outer cylindrical member is press-fitted.

3. The suspension member according to claim 1, wherein an angle provided inside the recess between a first surface located on a side opposite to one end into which a resin outer cylindrical member is press-fitted and an inner surface of the mount attachment portion is greater than or equal to 15 degrees and less than or equal to 30 degrees.

4. The suspension member according to claim 1, wherein an angle provided outside the recess between a second surface located on a side closer to one end into which a resin outer cylindrical member is press-fitted and an inner surface of the mount attachment portion is greater than or equal to 80 degrees and less than or equal to 100 degrees.

5. The suspension member according to claim 1, wherein the recess is provided such that a radial wall thickness of the mount attachment portion at the recess is substantially the same as a radial wall thickness of the mount attachment portion in a region other than the recess.
